(19) United States
(12) Patent Application Publication
(10) Pub. No.: US 2018/0345391 A1
(43) Pub. Date: Dec. 6, 2018

(54) Saw Assembly for a Metal Workpiece and Method for Sawing the Same

(71) Applicant: Piedmont Precision Products, Inc., Hickory, NC (US)

(72) Inventors: David A. Ridgway, Hickory, NC (US); Joshua R. Starnes, Hickory, NC (US)

(21) Appl. No.: 15/995,921

(22) Filed: Jun. 1, 2018

Related U.S. Application Data
(60) Provisional application No. 62/515,526, filed on Jun. 5, 2017.

(51) Int. Cl. B23D 61/02; B23D 59/00; B23D 47/02; B27B 5/29

(52) U.S. Cl. CPC B23D 61/021; B27B 5/29; B23D 47/025; B23D 59/001

(57) ABSTRACT

A saw assembly for cutting a metal workpiece and method for cutting the same holds a metal workpiece at a substantially vertical or a slightly tilted orientation relative to vertical axis while cutting a cross section of the metal workpiece. The saw assembly includes a frame for retaining and cutting the workpiece. The workpiece to be cut slides laterally across low friction support bars and rollers on the frame to achieve a desired sawing position relative to a saw subassembly. A blade assembly is raised and lowered through a saw pulley system guided by guiderails and blade assembly mounting mechanism.

### CROSS REFERENCE OF RELATED APPLICATIONS

This application claims the benefit of U.S. Provisional Application Ser. No. 62/515,526 filed Jun. 2, 2017 which is incorporated by reference herein in its entirety.

### TECHNICAL FIELD

The disclosure herein relates generally to a saw assembly for a metal workpiece and method for sawing the same that holds a metal workpiece in place while positioning and cutting a cross section of the metal workpiece.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Standard table saws include a flat surface, or table, with a circular saw blade extending vertically up through a slot in the table. The saw blade is mounted on an arbor which is driven by an electric motor directly, by belt, or by gears. The saw operator slides a workpiece on the table against and past the blade while the circular blade revolves at a high rate of speed (typically about 4,000 rpm) and cuts through the workpiece.

Typically, a saw is a cutting instrument consisting of a tough blade, wire, or chain with a hard-toothed edge. Saws are used to cut through material, such as metals used in fabrication. An abrasive saw has a powered circular blade designed to cut through metal. The cut in the metal is made by placing the toothed edge of the saw blade against the metal workpiece and moving it forcefully forth and less forcefully back or continuously forward. In automated versions of a metal saw, the saw blade rotates automatically through electrical means. Thus, the force to create sufficient abrasion for sawing the metal may be applied by hand, or powered by steam, water, or electricity.

It is also known that saw blades for sawing metals are made with teeth of a hard, wear-resistant material, such as tungsten carbide or high-speed steel. Hardness is, however, often accompanied by brittleness, and metal saw blades often fail by fracturing or chipping at the corners of the teeth, which are highly stressed in conventional saw blade configurations.

It is known in the art that a handheld circular saw and a standard, motorized circular saw is capable of creating straight cuts through most types of metal. The standard circular saw is effective for cutting metal if the proper blade is chosen. In general, circular saws accept abrasive, metal cut-off discs for metalworking projects. The metal workpiece is generally large, flat, and often not rigid. This may require clamping the metal workpiece, or measuring the metal workpiece relative to the saw, so as to achieve a precise cut.

Frequently a heavy metal workpiece must be cut in precise dimensions most often requiring multiple operators to manipulate and saw the metal workpiece on the ground surface. However, such cutting conditions often result in imprecise cuts. Further, the metal workpiece can be heavy, requiring multiple operators and much time and effort to manipulate the metal workpiece in an adequate position for sawing.

Saws for cutting metal workpieces exist but they generally lack certain desirable qualities. For example, it would be desirable for a saw assembly to securely retain the metal workpiece in a substantially upright and stationary position while cutting the workpiece. Moreover, it would be desirable to have measuring and clamping means to hold the workpiece for proper cuts and potentially a cooling and vacuuming apparatus for cooling the saw during operation. A workpiece lift that lifts a heavy metal workpiece onto a cutting frame thereby reducing the manpower required for workpiece placement would also be desired. Finally, a saw that can cut a cross section of a heavy metal workpiece with a high degree of accuracy and precision and that can be operated by a single worker is desired.

### SUMMARY

Illustrative embodiments of the disclosure are generally directed to a saw assembly for a metal workpiece and method for sawing the same. In one embodiment, the saw assembly comprises a frame for supporting a metal workpiece in a substantially upright position so as to hold the workpiece in place while a worker makes a cross sectional cut therethrough. The frame can hold the workpiece at a substantially vertical orientation or a slightly tilted orientation relative to a horizontal axis. In one embodiments, the metal workpiece rests upon a support platform built into the frame which supports most of the weight of the workpiece. In some embodiments, the support platform comprises rollers for convenient and relatively easy horizontal movement of workpiece along the length of the frame to achieve a desired sawing position relative to a saw blade assembly. In another embodiment, the frame comprises one or more low friction support bars which come into contact with a workpiece face and provide side support.

In one embodiment, the frame is fitted with a blade assembly for precise and efficient workpiece cutting. The blade assembly can comprise a plate that supports a saw blade, a motor, a handle and potentially various other components. In some embodiments, the weight of the blade assembly is counterbalanced by a pulley assembly, which may be mounted to the frame above the plate. The pulley assembly can comprise a counter weight which offsets the weight of the blade assembly to aid the operator so that he/she does not have to bear the full weight of the blade assembly.

The frame can be fitted with one or more guiderails disposed perpendicular to the low friction support bars. In one embodiment, the blade assembly is mounted to the guiderails wherein the guiderails serve to guide the blade assembly and thereby the blade as the workpiece is cut. In this embodiment, the blade assembly can be manually raised and lowered along the path and plane created by the guiderails. In one embodiment, the blade assembly is slidably engaged to the guiderails by one or more mounting members and in some embodiments, the mounting members can comprise bearings to substantially eliminate friction between the mounting members and the guiderails during repeated operation.

In another embodiment, the frame can incorporate a line gauge for measuring the position of the metal workpiece relative to the blade assembly. In one embodiment, the line gauge is disposed across the low friction support bar and, in yet another embodiment, the line gauge is disposed across the support platform upon which the workpiece rests on its end during operation. The frame can be equipped with one or more clamps for added workpiece security and stability during cutting.

In some embodiments, the saw assembly provides a workpiece lift for transporting the metal workpiece from point A to point B, for example from a stack of workpieces to the saw assembly. In one embodiment, the workpiece lift is fixed to the frame and comprises a pulley apparatus, an arm, a workpiece grip, and a chain.

In some embodiments, a shut-off switch is operationally connected to the motor of the blade assembly to enable fast, efficient powering off of the blade assembly. The saw assembly can further comprise a coolant delivery system that controls the temperature of the blade and workpiece during cutting. A vacuum apparatus may also be incorporated into the saw assembly design for removal of metal debris forming during the cutting process.

In some embodiments, the saw assembly efficiently cuts a cross section of metal workpieces that are 2″ thick or below. In another embodiment, the saw assembly efficiently cuts a cross section of metal workpieces that are 1.5″ thick or below.

In other embodiments, the saw assembly is fitted with a mounting bracket for fixedly mounting the frame to a surface, such as a wall. In one embodiment, the saw assembly is substantially mobile, for example, the assembly may be fitted with a plurality of wheels including castor wheels attached at the base of the frame.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a front perspective view of an exemplary saw assembly;

FIG. 2 illustrates a rear side perspective view of the saw assembly shown in FIG. 1 mounted to a wall surface;

FIG. 3 illustrates a perspective view of a base end of a frame, showing rollers, low friction support bars, clamp, and stop;

FIG. 4 illustrates a close-up view of an exemplary low friction support bar with a line gauge, rollers, and stop;

FIG. 5 illustrates a perspective view of an exemplary workpiece lift with grip device and pulley chains transporting a metal workpiece onto the frame;

FIG. 6 illustrates an elevated view of an exemplary carriage of a blade assembly and guiderails;

FIG. 7 illustrates an elevated view of an exemplary pulley system for assisting an operator with raising and lowering the blade assembly attached by cable to blade assembly carriage;

FIG. 8 illustrates a close-up view of an exemplary saw blade from the blade assembly shown in FIG. 6; and

FIG. 9 illustrates perspective view of an exemplary blade assembly carriage.

Like reference numerals refer to like parts throughout the various views of the drawings.

### DETAILED DESCRIPTION

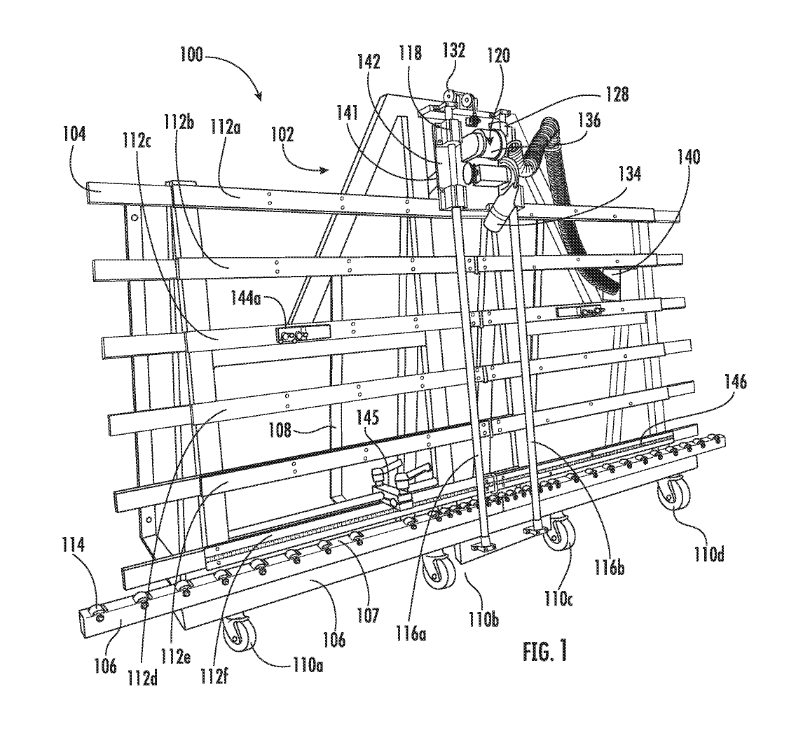

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment presented in FIGS. 1-9, a saw assembly 100 for cutting a metal workpiece 160 and method 1100 for cutting the same is configured to retain the metal workpiece 160 at a substantially vertical, or slightly tilted orientation relative to a vertical axis while cutting a cross section of the metal workpiece 160. A slight tilt in the metal workpiece is beneficial as it allows the heavy workpiece to rest against a support surface thereby preventing unwanted and dangerous tipping forward of the workpiece and potential injury to the saw assembly operator. The angle of the workpiece relative to the vertical axis can be at least 5 degrees. It should be understood, however, that other embodiments of the saw assembly may be fitted with mechanical structures designed to prevent unwanted forward workpiece tipping, for example clamps, brackets or braces. FIGS. 1-9 depict a saw assembly 100 with a frame 102 that supports a metal workpiece 160 in a substantially vertical, or slightly tilted orientation relative to a vertical axis as explained above.

In one embodiment, the frame 102 is mobile and capable of moving to positions proximate workpiece storage. In another embodiment, the frame 102 can be mountable to a wall to provide additional stability while cutting a workpiece. A base end 106 of the frame 102 can comprise a workpiece support platform 107 wherein the workpiece may be placed on the frame such that it rests upon the support platform 107 upon its end. The support platform 107 can comprise with a plurality of rollers 114 that contact and support the workpiece 160 and promote maneuverability of the workpiece by the operator along a horizontal plane defined by the support platform 107. The rollers 107 allow the saw assembly operator to maneuver the heavy workpiece into cutting position with relative ease and convenience.

In another embodiment, the frame 102 comprises a plurality of low friction support bars 112a-f traverse the frame 102. A properly positioned workpiece 160 upon frame 102 rests or leans against one or more of the low friction support bars 112a-f in a slightly tilted position relative to the vertical axis to avoid unwanted forward tipping and potential operator injury. In some embodiments, the rollers 114 and low friction support bars 112a-f work together enable the metal workpiece 160 to be moved laterally with minimal frictional resistance.

In another embodiment, the saw assembly 100 comprises a workpiece lift 138 for transporting the metal workpiece 160 from point A to point B, for example from a stack of stored workpieces to the saw assembly 100. In one embodiment, the workpiece lift is fixed to the frame and comprises a pulley apparatus, an arm, a workpiece grip, and a chain.

In another embodiment, the frame 102 can incorporate a line gauge 146. In one embodiment, the line gauge 146 extends across the low friction support bars 112a-f to enable measurement of the position of the metal workpiece 160 relative to a blade assembly 120. In yet another embodiment, the line gauge can be disposed across the support platform 107 upon which the workpiece rests on its end during operation, for example toward the front end of the platform 107 for better visibility.

As an additional security measure, the frame 102 can include one or more securing members 144a, 144b on the support bars 112a-f or other position upon frame 102 which secure the metal workpiece 160 to the support bars 112a-f for added workpiece stability during cutting and transportation. In one embodiment, the securing members 144a, 144b comprise clamps, brackets, braces or the like. The securing members 144a-b can be detachable so as not to interfere with the path of the workpiece as it is traveling down the rollers into cutting position. Once the workpiece is in cutting position, the securing members 144a-b can be mounted to the low friction support bars and/or the frame structure at any one of a plurality of predetermined points on the support bars, adjusted to overlap a portion of the workpiece 160 and then tightened such that the workpiece fits snugly against the low friction support bars 112a-f. In another embodiment, the frame 102 can also comprise a stop 145 to prevent unwanted horizontal movement of workpiece 160 while the securing members 144a-b are put in place.

The saw assembly 100 may be configured with a blade assembly 120 for cutting a cross section of the workpiece 160. In one embodiment, the blade assembly 120 comprises a carriage 141 which further comprises a saw plate 142 that carries a saw blade 122, a motor 126 which powers saw blade rotation, and a handle 124. In one embodiment, the blade assembly 120 can be manually raised and lowered to cut cross sections of the workpiece 160 with the aid of a pulley assembly 132. The pulley assembly 132 counterbalances the weight of the blade assembly 120 to reduce the burden on the operator.

In one embodiment, the frame is fitted with one or more guiderails or tracks to guide the blade assembly 120 and carriage 141 and saw blade 122 through a cut to increase precision and linearity of the cut. In one embodiment, a pair of guiderails 116a-b are affixed to and disposed across the frame 102, perpendicular to the horizontal low friction support bars 112a-f. In one embodiment, the carriage 141 is slidably engaged to the guiderails 116a-b by one or more mounting members 118a-b positioned on opposite sides of the saw plate 142. In some embodiments, the mounting members 143a-b can comprise bearings to substantially eliminate friction between the mounting members 118a-b and the guiderails 116a-b during repeated operation and vibration of the blade assembly 120 during operation. The carriage 141 rides the guiderails 116a-b into a sawing position for cutting the metal workpiece 160. In this embodiment, the blade assembly can be manually raised and lowered along the path and plane created by the guiderails. In another embodiment, the blade assembly 120 movement along the path created by the guiderails 116a-b is automatic and powered via hydraulic or pneumatic systems well known in the art.

In another embodiment, the saw assembly 100 comprises a coolant delivery system 134 that controls the temperature of the blade 122 and workpiece 160 during cutting operations. Additionally, the saw assembly 100 may comprise a vacuum apparatus 136 for removal of metal chips and debris that form near the saw blade 122 while cutting the metal workpiece 160. Such debris can interfere with blade 122 performance and impact cutting precision. In another embodiment, the saw assembly 100 may comprise an exhaust port 140 that is in communication with the vacuum apparatus 136 to remove harmful debris, dust, and gases that form while sawing.

Referring to the embodiment shown in FIG. 1, the saw assembly 100 comprises a frame 102. The frame 102 provides the structural integrity to support a heavy metal workpiece 160. The frame 102 may include a series of parallel beams, or multiple cross-bars arranged to form a generally rectangular shape. In some embodiments, the frame 102 is defined by an upper end 104 and a base end 106. The base end 106 of the frame 102 is oriented generally proximal to a ground surface. The frame 102 is configured to rest in a substantially vertical, or slightly tilted orientation during operation and to receive a workpiece 160 in the same orientation for cutting.

In one embodiment, the frame 102 is a steel frame that securely retains a metal workpiece 160. The metal workpiece can be a substantially square or rectangular metal plate that can weigh up to or slightly exceeding 1,000 lbs. In one embodiment, the metal workpiece has a thickness of about 2″ or below and, in another embodiment, the thickness can be about 1.5″ or below.

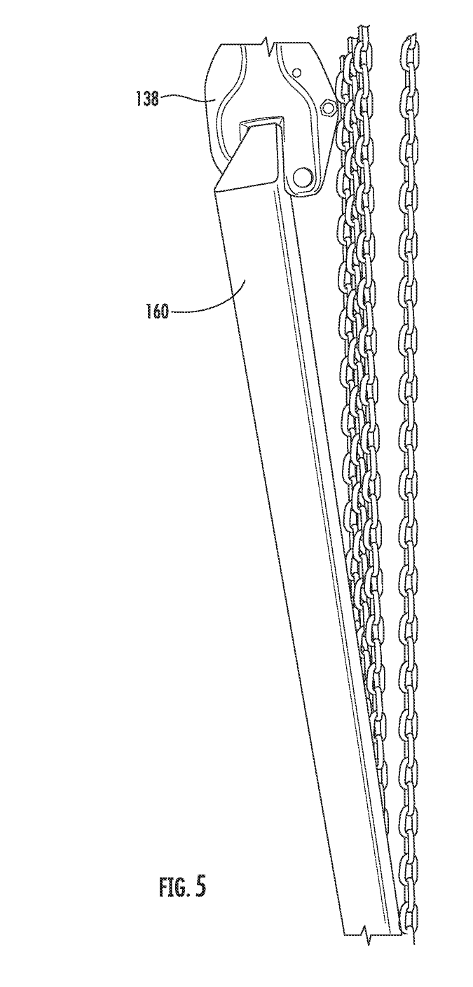

In another embodiment, a workpiece lift 138 retrieves and transports a metal workpiece 160 from a workpiece storage location to the frame 102 and positions the metal workpiece 160 on the frame 102 with the assistance of the saw assembly 100 operator. The workpiece lift 138 may include a chain-pulley system configured to lift and lower heavy, metal loads (FIG. 5). For example, a chain fall hoist (powered or manual) and/or jib crane may be used as a suitable workpiece lift 138. The workpiece lift 138 can be a permanent integral component of the saw assembly 100 or, alternatively, detachably secured to the saw assembly 100. In one embodiment, if the workpiece lift were integral to the frame, the frame 102 may comprise a pivoting boom arm (e.g. jib crane) with a chain fall hoist assembled thereon. In such embodiments, the frame 102 would need to be located or transported to an area proximate the workpiece 160 storage location.

In another embodiment, the workpiece lift 138 can be a separate component from the frame 102. In such embodiments, the lift 138 may be suspended from above (e.g., support beam) or attached to the floor, for example in the form of a column and jib crane structure. A workpiece lift 138 can be suspended from a track assembly whereby the lift 138 is allowed to move from point A to point B along the track. The workpiece lift 138 may be mobile and fitted with rollers or other mechanical structure promoting mobility for ease of workpiece 160 retrieval by an operator and transport to the frame 102. In one non-limiting embodiment, an electric controller/motor operates the chain-pulley system, but it may also be pneumatically and/or hydraulically powered.

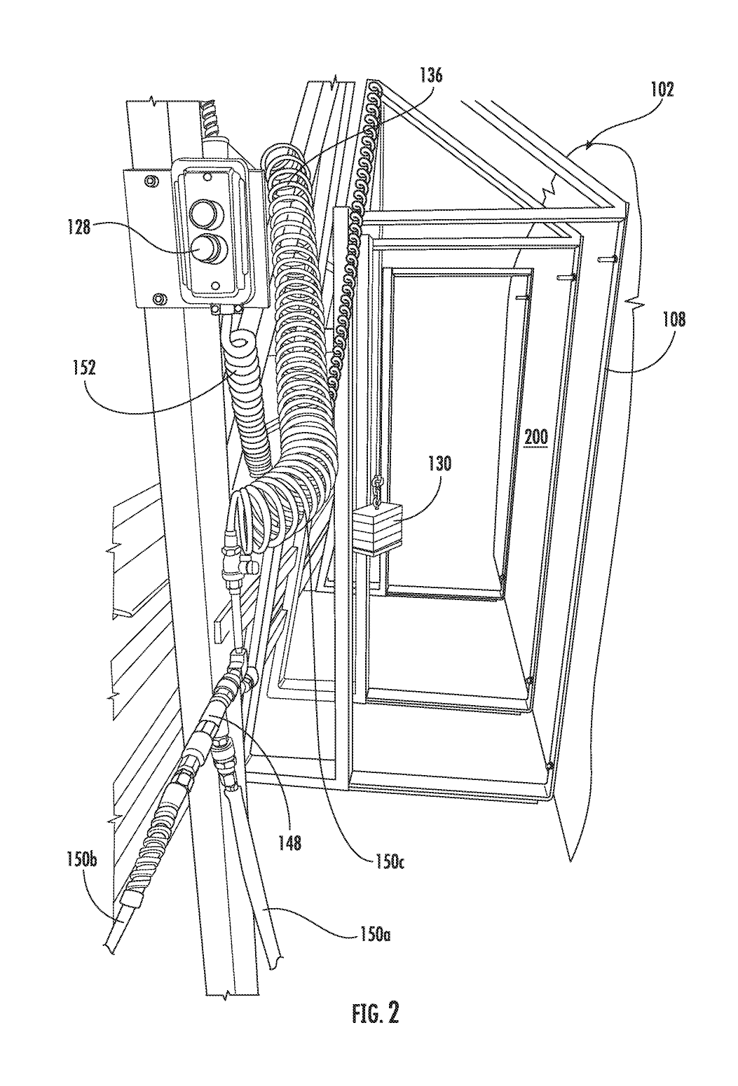

With reference to the embodiment in FIG. 2, the frame 102 can include a mounting mechanism 108 that allows the frame 102 to be mounted to a surface 200, such as a wall or other solid anchor. The mounting mechanism 108 may be a bracket or brace, such as the one depicted in FIG. 2, including a series of metal beams and plates that contain apertures for a fastener to pass through. In other embodiments, the saw assembly 100 is substantially mobile, for example, the assembly may be fitted with a plurality of wheels including castor wheels (see e.g., 110a-d) attached at the base of the frame. In such unmounted designs, other stabilizing mechanical techniques may be employed. For example, the frame 102 may comprise rear supports that extend rearward at a distance from the top of the frame 102 to the floor surface for maximum frame stability. Weighted anchors may also be utilized to anchor the rear supports to the floor. In some embodiments, the rear supports can be pivotably attached to the frame 102 allowing the supports to be folded in close to the frame 102 for ease of transport and mobility.

In other embodiments, the portion of the frame 102 that contacts and supports the rear face of a workpiece 160 which may include the low friction support bars 112a-f may also include a fulcrum about which to pivot at a slight angle relative to the vertical axis. However, in other embodiments, the frame 102 is fixedly tilted at a predetermined angle relative to the vertical axis. In one embodiment, the predetermined angle relative to the vertical axis is at least 5 degrees. The slightly tilted disposition allows heavier metal sheets to be supported more easily and avoid injury to the operator.

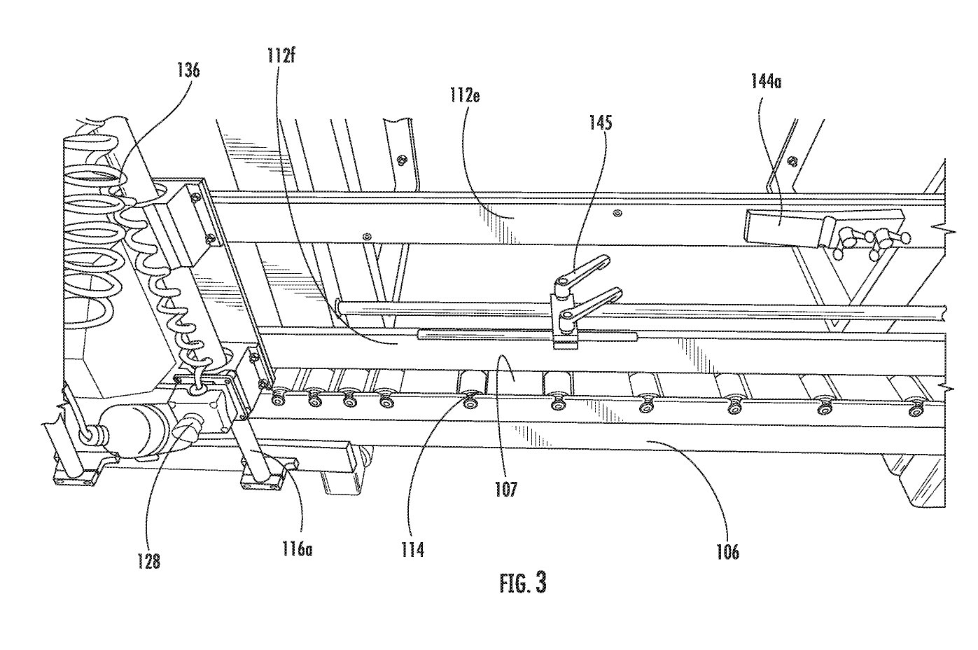

Referring now to FIG. 3, in some embodiments, the saw assembly 100 may comprise a mobile portion 110a-d, such as wheels, rollers, or sleds that are affixed to the base end 106 of the frame 102. The mobile portion 110a-d allows the frame 102 to be easily moved to different locations for mobile operation of the assembly 100. This mobility function can be useful when heavy metal workpieces must be loaded onto the frame 102.

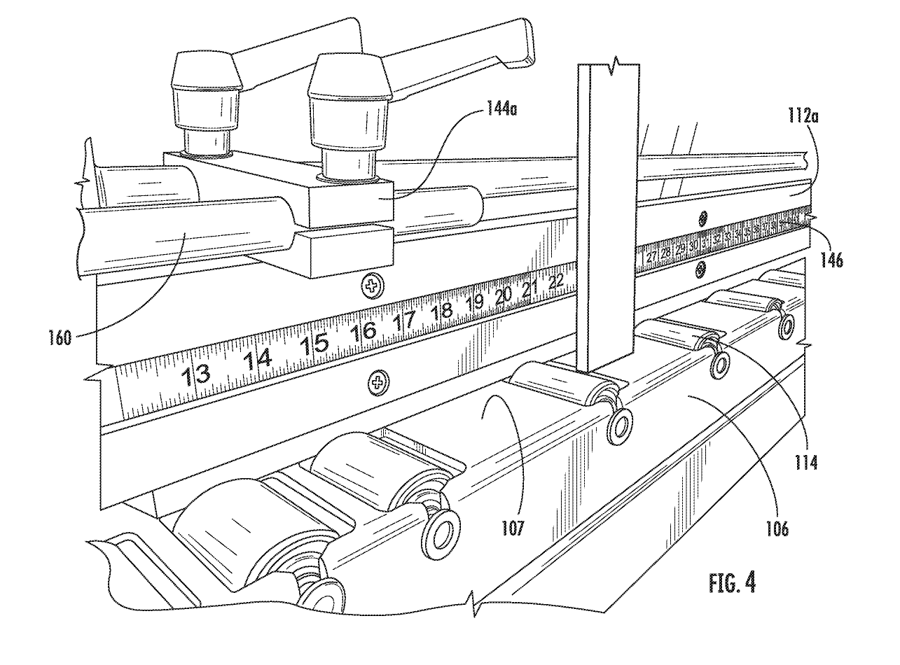

As FIG. 4 shows, frame 102 may comprise one or more low friction support bars affixed to the frame. In the embodiment illustrated in FIG. 4, six low friction support bars are disclosed 112a-f extending coplanar and in parallel across the frame 102 for direct contact with and support of the rear face of a workpiece 160 positioned for cutting. In one non-limiting embodiment, the six support bars 112a-f are disposed in a tiered, equally spaced-apart, parallel relationship on the frame 102. The support bars 112a-f are configured to provide a low friction surface for the metal workpiece 160 to be moved with relative ease horizontally upon rollers 114 disposed within platform 107 (and partially exposed) and precisely positioned for cutting. In some embodiments, the low friction support bars 112a-f may be elongated sleeves/panels that slide on and off the frame 102; however, in other embodiments, the support bars 112a-f are integrated into the frame 102, contributing to the structural integrity of the frame 102.

In another embodiment, the rollers 114 can be affixed to the frame 102 through, for example, a heavy-duty bolt/screw (e.g., 3″×1.75″) and threaded hole in the frame 102 without the platform 107. In this embodiment, the rollers 114 serve as the only underside support for the workpiece 160 and significantly reduce the tendency of other designs to collect metal chips that may substantially interfere with the roller function due to the empty space between adjacent rollers. Bushings (e.g. felt bushings) may be used to prevent unwanted chips from bearing contact and interfering with bearing function and damage. Rollers 114 can be 1.5″ in some embodiments. For added strength the rollers 114 can be 2″.

As shown in FIGS. 1, 3-4, rollers 114 can be positioned at predetermined positions relative to one another for maximum effectiveness. For example, roller concentration or density may be greatest toward the central portion of the frame 102 nearest the blade assembly 120 for finer positional adjustment of the workpiece and more spread apart toward the ends of the frame.

In some embodiments, the support bars 112a-f may be comprised of materials including thermoplastics, such as polytetrafluoroethylene (PTFE), classic wear materials made of polyimide, PEEK. PPS, nylon, acetal, PET, UHMW, PBT, and/or polyester. For example, Delrin® produced by DuPont™ are internally lubricated, wear resistant acetal resins that can be used. Vespel® is another DuPont™ product that may be used. Generally, any material with a sufficiently low coefficient of friction and that is wear-resistant can be used. Such materials can add lubricants to lessen friction or be internally lubricated. The materials may be applied in the form of coatings or laminates upon a solid substrate or the material may form all or a substantial part of the low friction support bar composition. Low-friction additives may also be used, such as PTFE, oil, carbon fiber, and graphite powder which improve the wear performance of polymers. It should be understood that the same or similar materials can be used for any mechanical component of the saw assembly 100 where a reduced friction coefficient is desired, such as for example in bearing components.

In one embodiment, the frame 102 comprises a line gauge 146 to enable measurement of the position of the metal workpiece 160 relative to a blade assembly 120. For example, a line gauge 146 can be positioned such that it extends across the low friction support bars 112a-f or across the front edge of the support platform 107 where it is visible to the operator.

Mechanical structures designed to prevent unwanted forward workpiece tipping may be added to or integral to the saw assembly 100, for example clamps, brackets, braces, and the like. In one embodiment, a pair of clamps 144a, 144b are fixed to support bars 112a-f securely clamp the metal workpiece 160 to the support bars 112a-f during transport and sawing. These integral clamps 144a-b eliminate the need to keep up with several C-clamps and also holds the metal workpiece 160 in a stable position relative to the saw blade. In this manner, a single operator can achieve a desired sawing position for the metal workpiece 160 relative to a blade assembly 120. For example, an operator can line up the edge of a metal sheet to the desired length of cut without having to measure from the saw blade 122 for every cut.

Looking again at the embodiment illustrated in FIG. 3, a plurality of rollers 114 extend across the base end 106 of the frame 102, particularly disposed within the support platform 107. A bottom edge of the metal workpiece 160 may be positioned to rest on the exposed portion of the rollers 114, while the rear face of the workpiece 160 rests on low friction support bars 112a-f. For example, one edge of the metal workpiece 160 rests on the rollers 114, while the plane surface of the metal workpiece 160 rests on low friction support bars made of or coated with Delrin®. In one non-limiting embodiment, the rollers 114 are 4″ wide with sealed bearings. Rails supporting the rollers are open at the bottom so that metal chips do not accumulate in and around the rollers 114, which can be obstructive to the metal workpiece 160.

The rollers 114 may rotate freely and utilize roller bearings to help support the weight of the metal workpiece 160. In this manner, the metal workpiece 160 is in position to slide horizontally in a coplanar disposition across the rollers 114 and the support bars 112a-f. This low friction motion allows a single operator to manipulate the metal workpiece 160 for sawing.

With reference to the embodiment in FIG. 2, the frame 102 is fitted with one or more guiderails or tracks to guide the blade assembly 120 and carriage 141 and saw blade 122 through a substantially linear cut. In one embodiment, a pair of guiderails 116a-b are affixed to and disposed across the frame 102, perpendicular to the horizontal low friction support bars 112a-f and extending between the upper end 104 and the base end 106 of the frame 102. The guiderails 116a-b provide a linear path for the saw subassembly 120 to follow, as described below. The guiderails 116a-b also maintain the saw blade 122 square to the metal workpiece 160 being sawn.

In one embodiment, the carriage 141 is slidably engaged to the guiderails 116a-b by one or more mounting members 118a-b positioned on opposite sides of the saw plate 142. In some embodiments, the mounting members 143a-b can comprise bearings to substantially eliminate friction between the mounting members 118a-b and the guiderails 116a-b during repeated operation and vibration of the blade assembly 120 during operation. The carriage 141 rides the guiderails 116a-b into a sawing position for cutting the metal workpiece 160. In this embodiment, the blade assembly can be manually raised and lowered along the path and plane created by the guiderails. In another embodiment, the blade assembly 120 movement along the path created by the guiderails 116a-b is automatic and powered via hydraulic or pneumatic systems well known in the art.

The mounting members 118a-b are configured to reduce friction between the blade assembly 120 and the guiderails 116a-b during movement of the carriage 141. The mounting members 118a-b also constrain movement of the carriage 141 on the guiderails and help support the weight of the metal workpiece 160. The mounting members 118 may house, without limitation, ball bearings or roller bearings (e.g., straight or spherical) to reduce friction and vibration of the carriage 141 during operation. The bearings may be made of metal or other durable materials, such as those discussed above in relation to the low friction support bars.

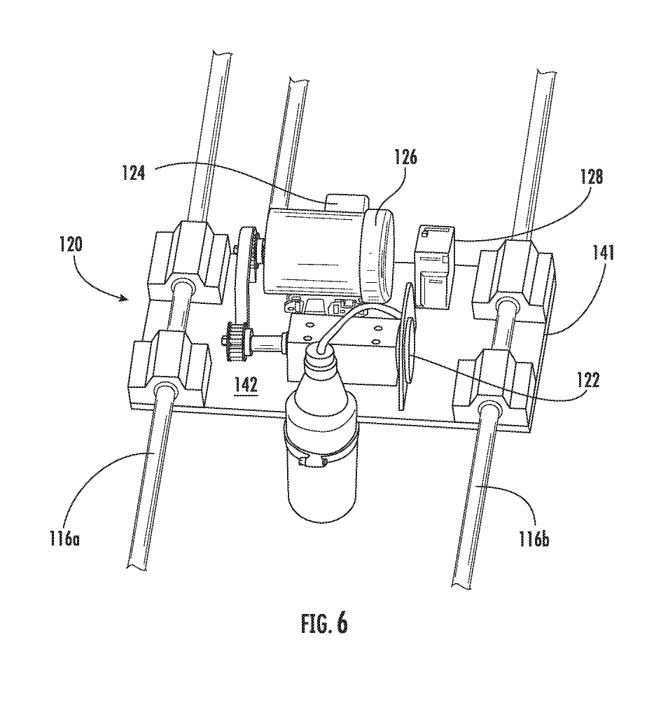

As referenced in FIG. 6, the assembly 100 further provides a blade assembly 120 that saws across a cross section of the metal workpiece 160. The blade assembly 120 can comprise a carriage 141 that includes, in some embodiments, a saw plate 142 that carries a saw blade 122, a handle 124, a motor 126. The saw plate 142 supports the motor 126 and a driveshaft closer to the work surface to reduce vibration and insure more accurate cutting tolerances.

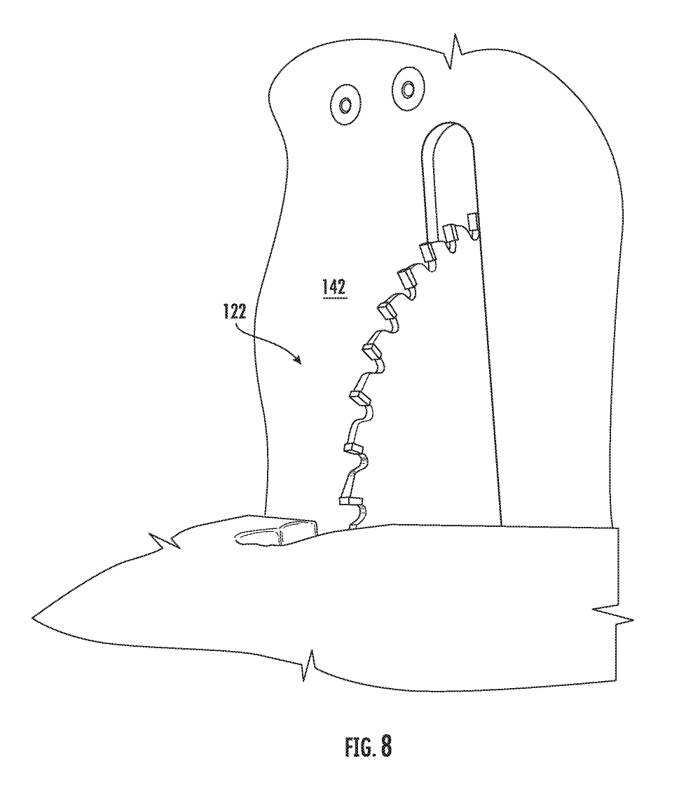

The saw blade 122 may include a durable circular saw that is configured to saw metal sheets (FIG. 8). In one embodiment, the saw blade 122 cuts non-ferrous metal workpieces such as aluminum. In another embodiment, the saw blade 122 cuts metal workpieces up to 1.5″ thick. In another embodiment, the saw blade 122 cuts metal workpieces up to 2″ thick. The motor 126 may comprise an electrical motor 126 (e.g., 1 HP) that is controlled to power on and off through a switch that is accessible proximate the handle 124 for operator convenience and quick accessibility. In one embodiment, a shut-off switch 128 positions near the saw blade 122 (FIG. 6). The shut-off switch 128 is operable to enable the motor 126 to be powered off quickly.

The blade assembly 120 may additionally comprise an electronic variable speed control system (variable speed drive) that efficiently allows the saw operator to adjust blade speeds through multiple phases, for example from phase 1 to phase 3. This speed control system can be contained at or near the shut off switch 128 and be included in the same structural component or a different component altogether.

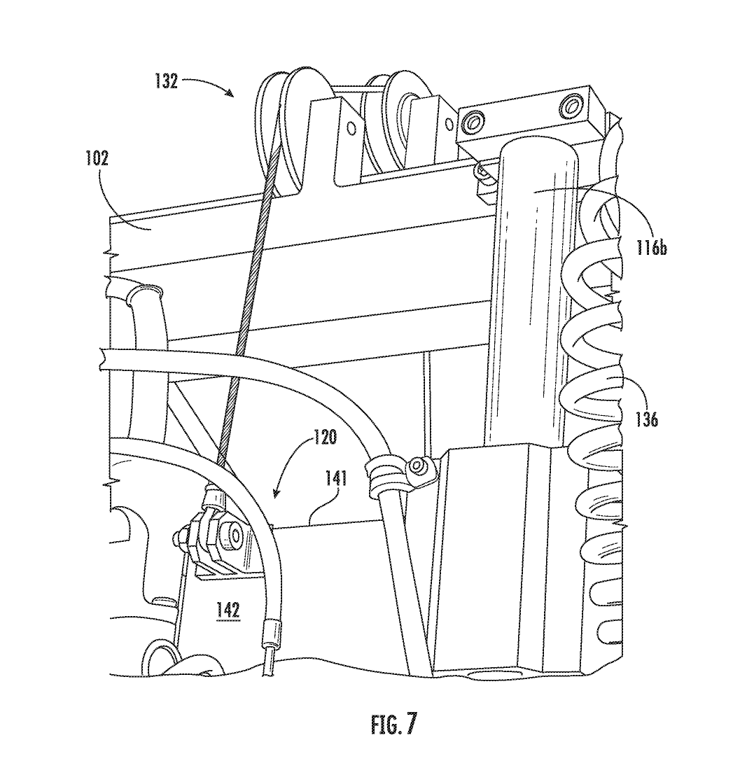

As FIG. 7 illustrates, in one embodiment, the blade assembly 120 can be manually raised and lowered to cut cross sections of the workpiece 160 with the aid of a pulley assembly 132. The pulley assembly 132 counterbalances the weight of the blade assembly 120 to reduce the burden on the operator by, for example, a counterweight 130. The pulley assembly 132 (e.g., through force applied by counterweight 130) applies upward force to the upper end of the carriage 141 pulling the blade assembly 120 upward along guiderails 116a, 116b to return the carriage 141 back to its upper most position on guiderails 116a-b following release by the operator. Preferably, the counterweight 130 is properly balanced with the carriage 141 such that it is sufficiently light requiring minimal operator strength to pull the carriage 141 through a cut while sufficiently heavy to gently return the carriage to its uppermost position once released without damage. FIG. 2 depicts an exemplary counterweight 130 tethered to the blade assembly 120. The counterweight 130 counters a downward force applied to the blade assembly 120 to saw the metal workpiece 160. Thus, the blade assembly 120 cannot saw downwardly unless an operator grasps the saw handle 124 and pulls down. After finishing the cut, the blade assembly 120 is pulled back up by the counterweight 130. This provides a safety feature that prevents the saw subassembly 120 from falling.

In one embodiment, the pulley(s) of the pulley assembly 132 are disposed at the upper end 104 of the frame 102 and a cable is attached to the upper end of the carriage at one end and a counter weight at the other. The pulley assembly 132 may utilize a standard wheel and cable to support the weight of the blade assembly 120 while being manually raised and lowered into position for cutting the metal workpiece 160.

In an alternative embodiment, the guiderails 116a-b, blade assembly 120, and pulley assembly 132 are adjustable in relation to the stationary frame. For example, these components can be affixed to a slide track system that potentiates lateral movement of the components. When the components, and the blade 122 in particular, are in the proper position in relation to the metal workpiece such that the blade 122 is in alignment with the desired cut line, the slide track system can be locked by a locking mechanism preventing further movement.

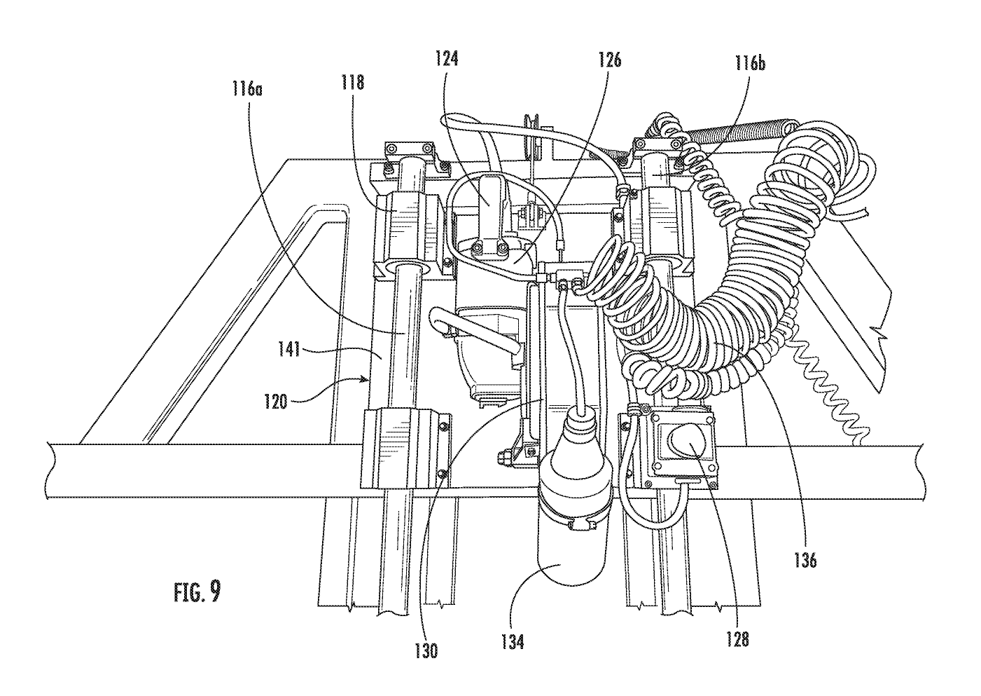

Turning now to the embodiment shown in FIG. 9, the saw assembly 100 comprises a coolant delivery system 134 that controls the temperature of the blade 122 and workpiece 160 during cutting operations. This helps reduce the heat near the saw blade 122, improves cutting rates by balancing the combination of cooling and lubrication of the blade, improves the cut finish and extends the blade life by as much as 20%. Coolant also helps prevent metal chips from welding to the tooth face and altering the chip removing capacity of the band gullets, dramatically affecting blade performance. In one embodiment, the coolant delivery system 134 comprises an air powered mister containing a coolant. Cutting fluids are various fluids that are used in machining to cool and lubricate the cutting tool. There are various kinds of metalworking fluids, including oils, oil-water emulsions, pastes, gels, and mists made from petroleum distillates, plant oils, or other raw ingredients. In one embodiment, the coolant delivery system is a flood system or a spray misting system. Such systems are known in the art.

Another potential feature of assembly 100 for creating a smooth sawing of the metal workpiece 160 is a vacuum apparatus 136 operable proximal to the saw blade 122 for removal of metal chips and debris that form near the saw blade 122 while cutting the metal workpiece 160. The vacuum apparatus 136 is also effective for collecting dangerous micro particles that float in the air near the operator. In some embodiments, an exhaust port 140 is in communication with the vacuum apparatus 136. The exhaust port 140 is utilizes to carry the collected debris away from the assembly 100. The exhaust port 140 not only helps keep the sawing area clean, but also prevents metal chips from getting into the roller bed and roller bearings.

The saw assembly 100 can further comprise a manifold 148 that regulates a plurality of air hoses 150a, 150b, 150c and a power cable 152 (as shown in FIG. 2). The air hoses 150a-c carry air for transporting air through the vacuum apparatus 136 and the exhaust port 140. The power cable 152 may be connected to a power outlet to carry electrical power for operation of the motor 126 in the saw subassembly 120.

In working operation, a saw operator may mount a saw assembly to a surface through a mounting bracket, the saw blade assembly comprising a frame defined by an upper end and a base end. The frame 102 provides the underlying supportive structure upon which a metal workpiece 160 is rested for sawing. The frame 102 may be slightly tilted or upper right, depending on the needs of the metal workpiece 160. However, it is significant to note that a heavier metal workpiece may be easier to saw when slightly inclined.

The operator may position, for example with a workpiece lift (e.g., crane device) or manually, a metal workpiece across a plurality of support bars that traverse the frame, and on a plurality of rollers at the base end of the frame, whereby the support bars and the rollers facilitate lateral displacement of the metal workpiece. Thus, the workpiece 160 rests on frictionless support bars 12a-f and rollers 114 that allow workpiece 160 to be slid laterally relative to a saw subassembly 120.

For example, one edge of the metal workpiece 160 rests on the rollers 114, while the plane surface of the metal workpiece 160 rests on slick, low friction support bars. In one embodiment, the workpiece lift 138 is used to pick up the metal workpiece 160 from a reservoir of workpieces for placement on frame 102.

The operator may measure, for example with a line gauge, a sawing position of the metal workpiece relative to the support bars and a blade assembly. In some embodiments, the operator may clamp the metal workpiece to the support bars or other frame 102 component. The measurement and clamping means provides precise positioning and secure fastening of the metal workpiece 160 for sawing.

The operator may position blade assembly to a desired sawing position adjacent to the metal workpiece, the blade assembly riding a pair of guiderails disposed on the frame perpendicular to the support bars. The pulley 132 can be operated manually or through an electronic winch. In any case, only one operator is required to operate the pulley system 132. In alternative embodiments, additional steps may include powering on the blade assembly. An electric motor 126 may be used to operate the saw subassembly 120. The switch may include On/Off positions and a speed regulator.

In some embodiments, the operatory may guide the blade assembly along the guiderails with a saw pulley system to saw the metal workpiece. The operator can use the saw pulley system 132 to raise and lower the blade assembly 120 along the guiderails 116a-b. The operator can also use the handle 124 on the blade assembly 120 to help guide the blade assembly 120 while sawing a cross-section of the metal workpiece 160. Either way, the carriage 141 attaches to the guiderails 116a-b so as to carry the carriage 141 across the frame 102 in a coplanar manner.

In operation, a coolant delivery system may discharge a coolant/lubricant towards the blade assembly and the metal workpiece, the coolant reducing temperature of a saw blade that extends from the blade assembly. The coolant can be directed towards the saw blade 122 to spray a mist of coolant while the saw blade 122 cuts through the metal workpiece 160.

A vacuum apparatus may remove metal debris that form on the saw blade from sawing of the metal workpiece. An exhaust port 140 in communication with the vacuum apparatus can carry the debris away from the assembly 100. In alternative embodiments, additional steps may include powering off the saw subassembly 120 with a shut-off switch 128. This can be useful when an expedited shut-off is required.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A saw assembly for a metal workpiece, the assembly comprising:
a frame defined by an upper end and a base end;
a plurality of support bars traversing the frame, the support bars forming a substantially frictionless surface;
a blade assembly for cutting a metal workpiece comprising a blade carriage, a saw plate, a saw blade supported by the saw plate, a handle, and a motor;
a pair of guide rails extending in parallel between the upper end and the base end of the frame, the pair of guide rails defining a substantially linear cutting plane and disposed perpendicular to the support bars;
wherein the blade carriage is mounted to the guide rails by mounting elements comprising roller bearings allowing low friction movement of blade carriage;
wherein the guide rails restrict the motion of the blade carriage to the substantially linear cutting plane; and
a plurality of rollers extending across the base end of the frame wherein the rollers, support the underside of the workpiece and promote horizontal movement of the workpiece along the frame.

2. The assembly of claim 1, further comprising a mounting bracket fixed to the frame for mounting the frame to a solid support surface.

3. The assembly of claim 1, wherein the frame and low friction support bars define a plane that is tilted relative to the vertical axis at an angle of 5 degrees.

4. The assembly of claim 1, wherein the frame and low friction support bars define a plane that is tilted relative to the vertical axis at an angle of 10 degrees.

5. The assembly of claim 1, further comprising at least one clamp for securing the metal workpiece to the frame flush against the low friction support bars.

6. The assembly of claim 1, further comprising a line gauge comprising equally spaced measurement markings for measuring the position of the metal workpiece relative to the blade assembly.

7. The assembly of claim 6, wherein the line gauge is visibly disposed on the substantially flat horizontal surface of the support platform.

8. The assembly of claim 1, further comprising a workpiece lift for retrieving and transporting a workpiece to the frame.

9. The assembly of claim 8, wherein the workpiece lift comprises a chain pulley.

10. The assembly of claim 1, further comprising a pulley system disposed at the upper end of the frame and connected to an upper end of the blade carriage whereby the pulley system applies an upward force to the blade carriage and promotes upward movement of the blade carriage along the guide rails.

11. The assembly of claim 9, wherein the pulley system comprises a wheel, a cable, and a counterweight attached to the blade carriage by cable for offsetting the weight of the blade carriage.

12. The assembly of claim 1, further comprising a shut-off switch operably connected to the motor of the blade assembly, the shut-off switch operable to power off the motor.

13. The assembly of claim 1, wherein the blade assembly comprises an electronic speed control system.

14. The assembly of claim 1, further comprising a stop for preventing unwanted lateral movement of the workpiece.

15. The assembly of claim 1, wherein the plurality of low friction support bars comprise elongated, broad panels.

16. The assembly of claim 1, wherein the plurality of low friction support bars comprise the acetal resin Delrin®.

17. The assembly of claim 1, wherein the plurality of rollers are have the greatest density underneath the blade assembly for precision positional adjustment of the workpiece.

18. The assembly of claim 1, wherein the base end of the frame comprises a support platform that houses the plurality of rollers partially exposing the plurality of rollers for workpiece contact.

19. The assembly of claim 1, wherein the metal workpiece is a non-ferrous metal sheet.

20. The assembly of claim 15, wherein the non-ferrous metal sheet is aluminum.

21. The assembly of claim 1, wherein the metal workpiece is 1.5 inches thick.

22. A saw assembly for sawing a metal workpiece, the assembly comprising:
a frame defined by an upper end and a base end;
a mounting bracket attached to the frame;
a plurality of wheels disposed near the base end of the frame;
a plurality of low friction support bars traversing the frame, the support bars forming a substantially frictionless surface;
a plurality of rollers extending across the base end of the frame,
whereby the support bars and the rollers are operational to enable carrying a metal workpiece laterally across the frame;
at least one clamp attached to the support bars;
whereby the clamp is operational to enable fixedly clamping the metal workpiece to the support bars;
a pair of guiderails extending between the upper end and the base end of the frame, the pair of guiderails disposed perpendicular to the support bars;
a blade assembly comprising a saw plate, the saw plate supporting a saw blade, a handle, and a motor,
whereby the blade assembly is operational to cut the metal workpiece;
a line gauge disposed across a support bar that is most proximal to the base end of the frame, the line gauge comprising equally-spaced measurement markings,
whereby the line gauge is operational to enable measuring the position of the metal workpiece relative to the saw subassembly;
a pulley system disposed at the upper end of the frame, the pulley system operational to displace the saw subassembly along the guiderails;
a bearing portion operational with the pair of guiderails and the saw pulley system, the bearing portion constraining motion of the saw plate across the pair of guiderails, the bearing motion further helping to support the weight of the subassembly;
a cooling apparatus disposed proximally to the saw subassembly, the cooling apparatus comprising an air hose and an air powered mister containing a coolant, the cooling apparatus discharging the coolant towards the saw blade;
a vacuum apparatus disposed proximally to the saw subassembly, the vacuum apparatus sucking metal debris proximal to the saw blade;
an exhaust port in communication with the vacuum apparatus;
a shut-off switch operable to power off the motor of the saw subassembly; and
a workpiece lift disposed adjacent to the frame,
whereby the workpiece lift is operable to raise and lower the metal workpiece to the frame.

23. The assembly of claim 18, wherein the mounting bracket fixedly mounts the frame to a solid surface.

24. A method for sawing a metal workpiece with a saw assembly, the method comprising:
mounting a saw assembly to a surface through a mounting bracket, the saw blade assembly comprising a frame defined by an upper end and a base end and tilted in relation to the vertical axis;
positioning, with a workpiece lift, a metal workpiece across a plurality of low friction support bars that traverse the frame, and on a plurality of rollers at the base end of the frame, whereby the support bars and the rollers facilitate lateral displacement of the metal workpiece;
measuring, with a line gauge, a sawing position of the metal workpiece relative to the support bars and a blade assembly;
clamping, with a clamp, the metal workpiece to the support bars such that the workpiece is substantially stationary and flush against the support bars;
adjustably positioning the blade assembly to a desired sawing position adjacent to the metal workpiece, the blade assembly riding a pair of guiderails disposed on the frame perpendicular to the support bars;
guiding the blade assembly along the guiderails with a saw pulley system to saw the metal workpiece;
discharging, with a cooling apparatus, a coolant towards the saw subassembly and the metal workpiece, the coolant reducing temperature of a saw blade that extends from the saw subassembly; and
sucking, with a vacuum apparatus, metal debris that form on the saw blade from sawing of the metal workpiece.
